(19) United States
(12) Patent Application Publication
(10) Pub. No.: US 2005/0017926 A1
(43) Pub. Date: Jan. 27, 2005

(54) Image display apparatus

(75) Inventor: Yoshiji Tsuzuki, Honjo-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/887,302

(22) Filed: Jul. 9, 2004

(30) Foreign Application Priority Data
Jul. 11, 2003 (JP) 2003-195979

(51) Int. Cl. G09G 3/28

(52) U.S. Cl. 345/60

(57) ABSTRACT

An image display apparatus with discharge devices comprises a display section which displays an image by causing phosphors to emit light by the discharge energy of the discharge devices, and a discharge frequency control section which controls the discharge frequency of the discharge devices so as to prevent the discharge frequency and its integral-degree harmonic frequencies from coinciding with a public broadcasting frequency in an area where the apparatus is installed.

### CROSS-REFERENCE TO RELATED APPLICATIONS

This application is based upon and claims the benefit of priority from prior Japanese Patent Application No. 2003-195979, filed Jul. 11, 2003, the entire contents of which are incorporated herein by reference.

### BACKGROUND OF THE INVENTION

1. Field of the Invention

This invention relates to an image display apparatus which displays moving images, still images, or character codes (hereinafter, generically called images). More particularly, this invention relates to an image display apparatus using a discharge device, such as a panel display apparatus.

2. Description of the Related Art

A panel display apparatus, such as a plasma display panel (PDP), has discharge devices formed pixel by pixel. When as high a voltage as about 200V is applied to the discharge devices, the devices discharge. Ultraviolet rays generated from the discharge energy are irradiated to the phosphors. As a result, the pixels emit light, thereby displaying an image. When the PDP is driven, the discharge frequency is constant. The value of the discharge frequency is determined by the manufacturer on the basis of the panel performance, control circuit performance, and so forth.

It is well known that noise of a frequency coinciding with the discharge frequency develops whenever a discharge device discharges. Since noise appears even in the higher harmonic part of the noise source frequency, this gives rise to noise of the discharge frequency and its higher harmonic frequencies.

In Japan, AM radio broadcasting frequencies are allocated at intervals of 9 kHz in the range of 531 to 1602 kHz. This is expressed by the following equation: AM radio broadcasting frequencies=(531+9×n) kHz (n: 0, 1, 2, 3, . . . , 118, 119). Since 531 is a multiple of 9, AM radio frequencies are a multiple of 9. Not only Japan but also many other countries use such a frequency allocation.

When the discharge frequency of a PDP is, for example, 207 kHz, a multiple of 9, higher harmonics lying in the AM radio band (531 kHz to 1062 kHz) are 621, 828, 1035, 1242, and 1449 kHz. All of the frequencies coincide with the AM radio frequencies. That is, when the PDP is driven, broadcasting using a frequency in the frequency range is interfered with.

Under the present conditions, measures are taken to suppress the emission of noise by, for example, providing an electromagnetic interference (EMI) glass filter on the image display screen of the PDP. However, since the discharge voltage is as high as about 200V, the noise level is very high. When the screen size is large, the noise generation area is also large. From these, even if the shield performance is made higher, this does not lead to an ultimate solution at present.

The discharge frequency of an existing PDP has been determined on the basis of the required performance (including emission luminance and restrictions on the control circuit). Therefore, when the discharge frequency is set to 207 kHz, all of its higher harmonic frequencies coincide with the AM radio frequencies. In such a situation, it may be that AM radio broadcasting is impossible to listen to. In addition, since the AM radio band has not been included in legal restrictions on EMI, the panel manufacturers are reluctant to take measures. As described above, the existing PDP has the disadvantage of interfering significantly with public broadcasting, such as AM radio.

Related techniques have been disclosed in Jpn. Pat. Appln. KOKAI Publication No. 10-149136 (a first reference) and in Japan Display '92 “S16-2A Full Color AC Plasma with 256 Gray Scale,” pp. 605-608 (a second reference). The first reference has disclosed a PDP driving method which alleviates high-frequency interference with the displayed image by changing the frequency of the display clock on an image frame basis. The second reference has disclosed a general description of the operation of a PDP.

### BRIEF SUMMARY OF THE INVENTION

According to an aspect of the present invention, there is provided an image display apparatus with discharge devices comprises a display section which displays an image by causing phosphors to emit light by the discharge energy of the discharge devices; and a discharge frequency control section which controls the discharge frequency of the discharge devices so as to prevent the discharge frequency and its integral-degree harmonic frequencies from coinciding with a public broadcasting frequency in an area where the apparatus is installed.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block diagram of a first embodiment of an image display apparatus according to the present invention;

FIG. 2 is a conceptual diagram showing the contents of the channel setting table 23a of FIG. 1;

FIG. 3 is a conceptual diagram showing the contents of the discharge frequency setting table 23b of FIG. 1;

FIG. 4 is a schematic perspective sectional view showing a structure of the display panel 26 of FIG. 1; and

FIG. 5 shows the relationship between the higher harmonic frequencies of the discharge frequency of the display electrode 4 and the AM radio band.

### DETAILED DESCRIPTION OF THE INVENTION

Hereinafter, referring to the accompanying drawings, embodiments of the present invention will be explained in detail.

### FIRST EMBODIMENT

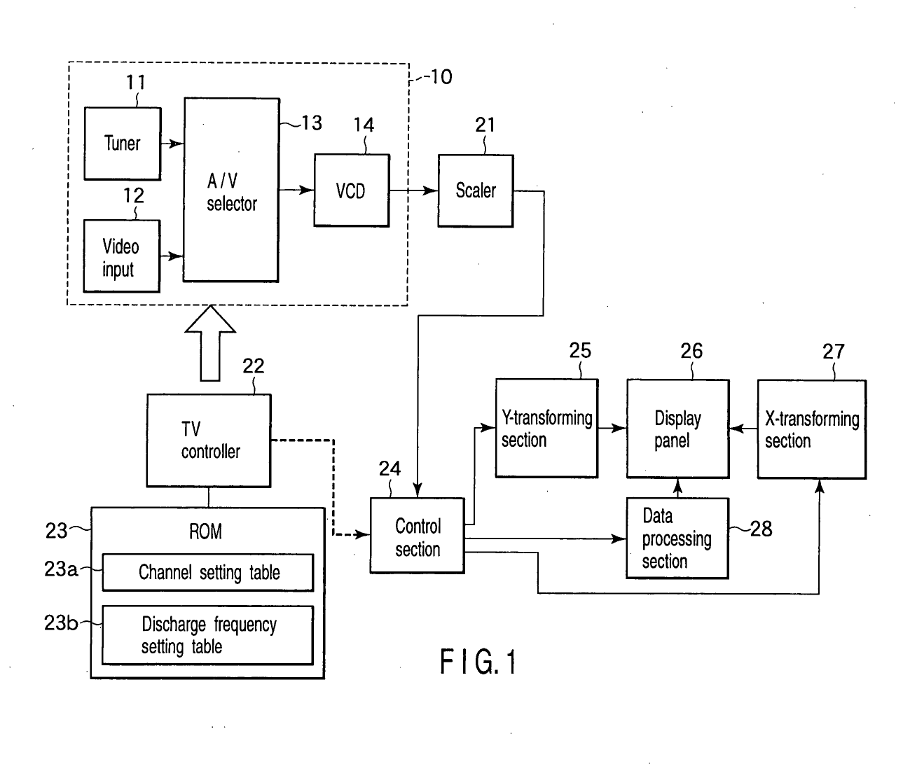

FIG. 1 is a functional block diagram of a first embodiment of an image display apparatus according to the present invention. In FIG. 1, a video signal output from a signal processing section 10 is supplied to a control section 24 via a scaler 21. The signal processing section 10 is controlled by a TV controller 22 on the basis of the data stored in a read-only memory (ROM) 23.

The control section 24 acquires various data from the video signal and supplies the data to a data processing section 28. The video signal is also supplied to a Y-transforming section 25 and an X-transforming section 27. The Y-transforming section 25 and X-transforming section 27 compress and expand the video size according to the display size of a display panel 26. The data processing section 28 controls the display panel 26 on the basis of the given data.

The ROM 23 stores a channel setting table 23a and a discharge frequency setting table 23b into a specific storage area.

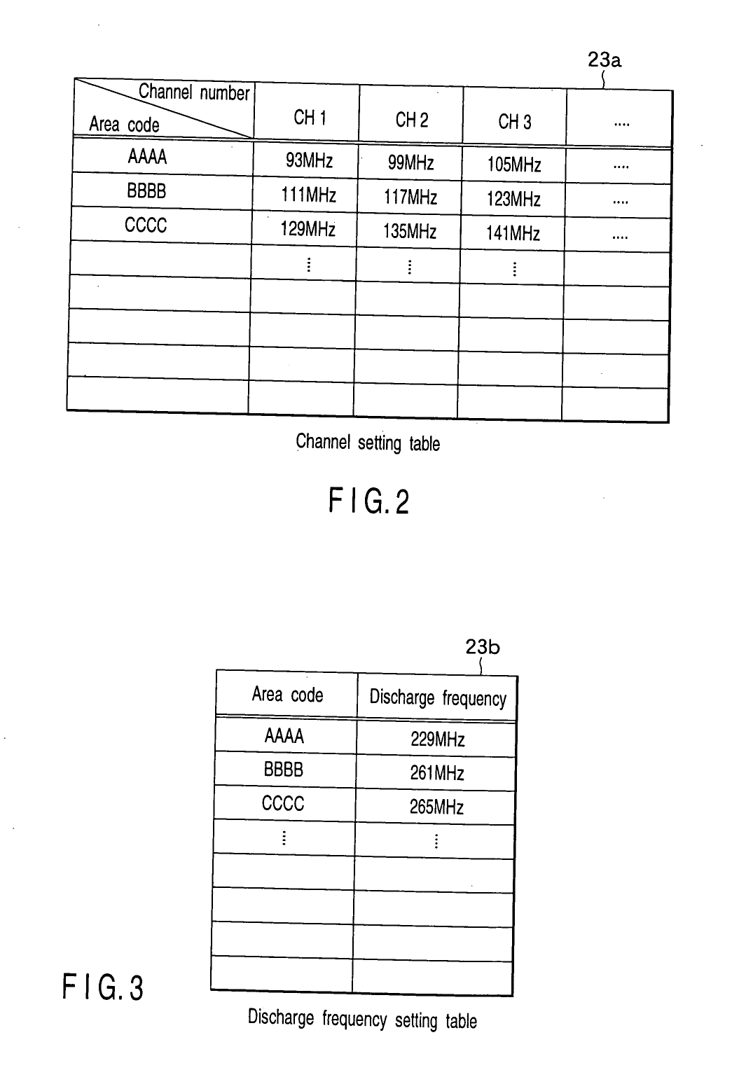

FIG. 2 is a conceptual diagram showing the contents of the channel setting table 23a of FIG. 1. The channel setting table 23a relates area codes allocated to a plurality of areas into which the country is divided to the TV broadcasting frequencies in the individual areas. When the user specifies an area code by remote control, the specification is recognized by the TV controller 22. Then, the reception frequency of a tuner 11 is set automatically on the basis of the channel setting table 23a. This type of function may be called an area setting function.

FIG. 3 is a conceptual diagram showing the contents of the discharge frequency setting table 23b of FIG. 1. The discharge frequency setting table 23b relates the discharge frequencies to be set in the display panel 26 to the individual area codes. When an area code is given, the optimum value of the discharge frequency according to the area is set automatically.

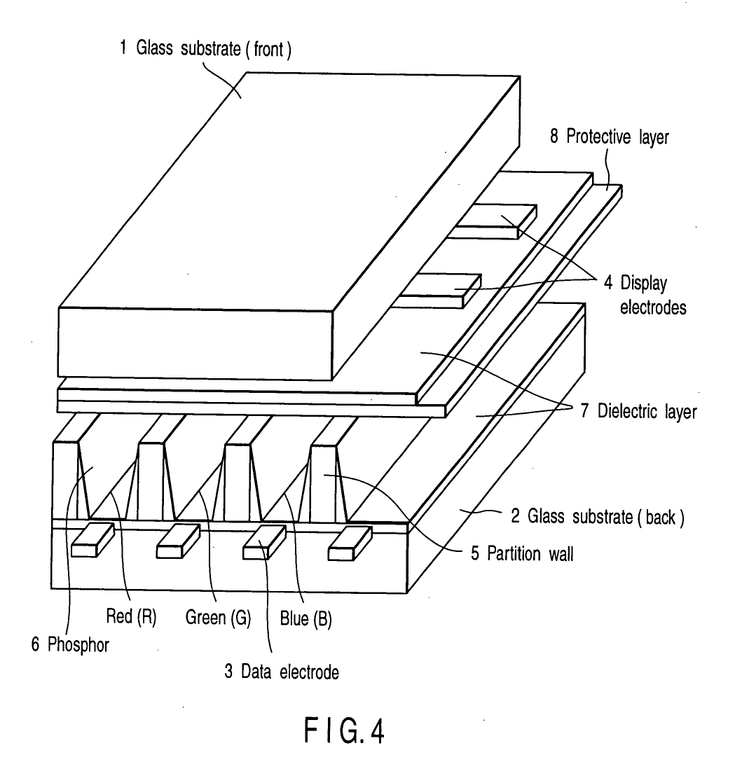

FIG. 4 is a schematic perspective sectional view showing a structure of the display panel 26 of FIG. 1. In FIG. 4, data electrodes 3 are formed on a glass substrate 1 and display electrodes 4 are formed on a glass substrate 2. The data electrodes 3 and display electrodes 4 are formed crosswise in a matrix. Data for display are written into the data electrodes 3. The display electrodes 4, which are so-called discharge devices, discharge electricity, thereby causing phosphors to emit light. The display electrodes 4 are formed in units of two. To isolate discharges taking place at adjacent discharge cells from one another, the data electrodes 3 are partitioned by strip-like partition walls 5.

Red (R), green (G), and blue (B) phosphors are applied so as to cover the data electrodes and partition walls, with the result that an R cell, a G cell, and a B cell constitute a single pixel. Then, the glass substrates 1 and 2 are laminated together with a dielectric layer 7 and a protective film 8 between them and a mixed gas of Ne and Xe is sealed. Each of the intersections of the data electrodes 3 and the display electrodes 4 forms a cell.

As high a voltage as about 200V is applied to the display electrodes 4, with the result that the display electrodes 4 discharge electricity. At this time, noise is generated. The noise frequency can be changed by controlling the discharge frequency of the display electrodes 4. The discharge frequency is determined according to the material characteristics of the phosphors 6 of FIG. 4, the length of the address period in the sub-field, and so forth. In the first embodiment, the control section 24 changes the value of the discharge frequency.

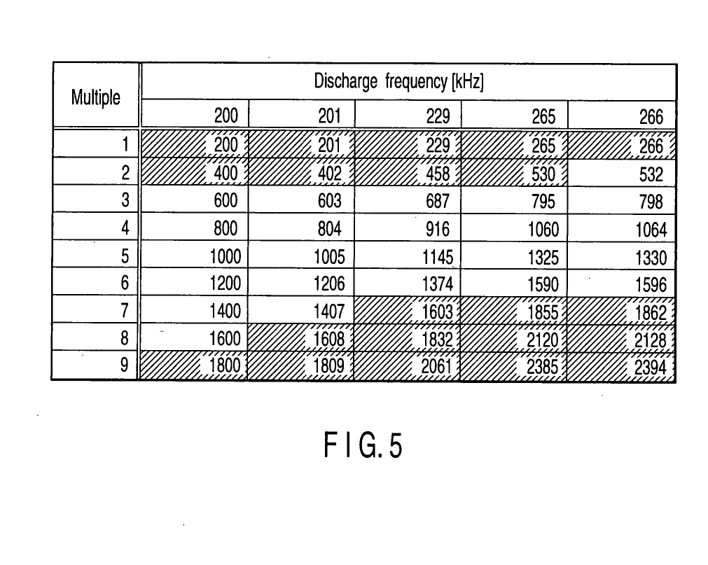

FIG. 5 shows the relationship between the higher harmonic frequencies of the discharge frequency of the display electrode 4 and the AM radio band. In FIG. 5, higher harmonic frequencies lying in the AM radio band are shown with a shaded background. FIG. 5 shows the discharge frequencies and their harmonics up to the ninth one.

As shown in FIG. 5, it is seen that the number of higher harmonic frequencies lying in the AM radio band becomes the smallest in the discharge frequency range of 229 to 265 kHz (four in this case). FIG. 5 also shows that the third to sixth harmonic frequencies of the discharge frequency in the range lie in the AM radio band.

In FIG. 5, the seventh harmonic (1603 kHz) of a discharge frequency of 229 kHz is only 1 kHz away from the AM radio frequency of 1602 kHz. Similarly, the second harmonic (530 kHz) of a discharge frequency of 265 kHz is only 1 kHz away from the AM radio frequency of 531 kHz. When the interval between frequencies is only 1 kHz, the effect of noise is liable to be greater.

In the first embodiment, to overcome this problem, the following condition is imposed: the frequency interval between the higher harmonics of the discharge frequency and the AM radio band should be, for example, 5 kHz or higher. Then, a discharge frequency which meets the condition and has four higher harmonic frequencies is in the range of 230 to 263 kHz.

Suppose a discharge frequency is expressed as (9×m+1) kHz, where m is an integer. The third to sixth harmonic frequencies of the discharge frequency are expressed as the following equations:
Third harmonic: 3×(9×m+1)=(9×(3×m)+3) kHz
Fourth harmonic: 4×(9×m+1)=(9×(4×m)+4) kHz
Fifth harmonic: 5×(9×m+1)=(9×(5×m)+5) kHz
Sixth harmonic: 6×(9×m+1)=(9×(6×m)+6) kHz

As described above, any of the third to sixth harmonic frequencies is expressed as a multiple of 9 plus the remainder.

Since the AM radio frequencies are a multiple of 9, the third to sixth harmonic frequencies of the discharge frequency are the remainder away from the AM radio frequencies. That is, the third to sixth harmonic frequencies do not coincide with the AM radio frequencies and are almost intermediate between the AM radio frequencies. The more the third to sixth harmonic frequencies are separate from the AM radio frequencies, the more the radio interference is reduced.

This holds true when the discharge frequency is (9×m−1) kHz, where m is an integer. Discharge frequencies which satisfy (9×m+1) or (9×m−1) kHz (where m is an integer) in the range of 229 to 265 kHz are the following eight frequencies: 233, 235, 242, 244, 252, 253, 260, 262 kHz.

In the first embodiment, the discharge frequency of the display electrode 4 is tuned to any of those frequencies. By doing this, the discharge frequency itself can be separated sufficiently from the AM radio frequency. Similarly, the integral-degree harmonic frequencies of the discharge frequency can be separated sufficiently from the AM radio frequencies. Therefore, this can eliminate the possibility that reception interference will occur in AM radio.

### SECOND EMBODIMENT

Next, a second embodiment of the present invention will be explained.

Suppose the discharge frequency is 261 kHz. Of the higher harmonic frequencies of the discharge frequency, the ones lying in the AM radio band are the following four frequencies: 783, 1044, 1305, 1566 kHz. All of these frequencies are a multiple of 9 and coincide with the AM radio frequencies. However, there is no AM station which uses the four frequencies in Japan at present. That is, setting the discharge frequency to 261 kHz makes it possible to minimize interference with AM radio in Japan at present. The same holds true for any other country in the world.

### THIRD EMBODIMENT

Next, a third embodiment of the present invention will be explained.

In the third embodiment, the discharge frequency of the display electrode 4 is designed to be changeable to any one of a plurality of switching values. In the third embodiment, two fixed values, 230 kHz and 260 kHz, are considered as the switching values. The discharge frequency is switched by the control section 24 according to a command give by the user.

The number of AM stations receivable in each area is not so large. If the discharge frequency is 230 kHz, the ones of its higher harmonic frequencies lying in the AM radio band are 690, 920, 1150, and 1380 kHz. If the discharge frequency is 260 kHz, the ones of its higher harmonic frequencies lying in the AM radio band are 780, 1040, 1300, and 1560 kHz.

For example, it is assumed that, when the discharge frequency is 230 kHz, AM radio interference has occurred. In this case, when the discharge frequency is switched to 260 kHz, the higher harmonic frequencies shift several tens of kHz. Therefore, AM radio interference can be reduced remarkably. The number of selectable discharge frequencies is not limited to two and may be three, four, or more.

### FOURTH EMBODIMENT

In recent years, many TV sets with an area setting function have been provided. Before using a display device with the area setting function for the first type, the user inputs to the system an area code corresponding to the area in which the TV set is installed. The area code is supplied to the system by selecting the area corresponding to the installation location of the device from the menu displayed on the screen or inputting the postal code for the area. A remote controller is used for such operation.

The area codes can be related to the frequency bands of AM public broadcasting for the individual areas. Once the frequency band of AM public broadcasting is found, a discharge frequency capable of minimizing interference can be known beforehand. Therefore, the discharge frequency setting table 23b of FIG. 3 can be prepared beforehand.

In the fourth embodiment, the discharge frequency of the display electrode 4 is set so as to correspond to the input area code. That is, when an area code is input, the discharge frequency corresponding to the code is set on the basis of the contents of the discharge frequency setting table 23b. As a result, the discharge frequency is set automatically by just setting the area code. Therefore, the problems for the user can be eliminated. As described in detail, with the present invention, it is possible to provide an image display apparatus which reduces interference with public broadcasting, such as AM radio broadcasting.

The present invention is not limited to the above embodiments. For instance, while each of the above embodiments has been explained using a PDP as an example, the invention may be applied to all of the display apparatuses which display images by use of discharge devices.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image display apparatus with discharge devices comprising:
a display section which displays an image by causing phosphors to emit light by the discharge energy of the discharge devices; and
a discharge frequency control section which controls the discharge frequency of the discharge devices so as to prevent the discharge frequency and its integral-degree harmonic frequencies from coinciding with a public broadcasting frequency in an area where the apparatus is installed.

2. The image display apparatus according to claim 1, wherein, when there are a plurality of public broadcasting frequencies in the area, the discharge frequency control section controls the discharge frequency in such a manner that the discharge frequency and its integral-degree harmonic frequencies are located almost in the middle of the intervals between said plurality of public broadcasting frequencies.

3. An image display apparatus with discharge devices comprising:
a display section which displays an image by causing phosphors to emit light by the discharge energy of the discharge devices; and
a discharge frequency control section which sets the discharge frequency of the discharge devices to either (9n+1) kHz or (9n−1) kHz, where n is an integer.

4. The image display apparatus according to claim 3, wherein the discharge frequency can be switched to any one of a plurality of frequency values, and
the discharge frequency control section selects any one of said plurality of frequency values according to an area where the apparatus is installed.

5. The image display apparatus according to claim 4, further comprising a tuner which receives a television broadcast wave transmitted from a broadcasting station in the area and demodulates an image signal to display an image on the image display apparatus, and
a frequency setting section which sets a reception frequency in the tuner according to a specified area code,
wherein the discharge frequency control section selects one frequency value corresponding to the area code from said plurality of frequency values.

6. An image display apparatus with discharge devices comprising:
a display section which displays an image by causing phosphors to emit light by the discharge energy of the discharge devices; and
a discharge frequency control section which sets the discharge frequency of the discharge devices in a range of 229 kHz to 265 kHz.

7. The image display apparatus according to claim 6, wherein the discharge frequency control section sets the discharge frequency to 261 kHz.

8. The image display apparatus according to claim 6, wherein the discharge frequency can be switched to any one of a plurality of frequency values, and
the discharge frequency control section selects any one of said plurality of frequency values according to an area where the apparatus is installed.

9. The image display apparatus according to claim 8, further comprising a tuner which receives a television broadcast wave transmitted from a broadcasting station in the area and demodulates an image signal to display an image on the image display apparatus, and
a frequency setting section which sets a reception frequency in the tuner according to a specified area code,
wherein the discharge frequency control section selects one frequency value corresponding to the area code from said plurality of frequency values.
